(19) United States
(12) Patent Application Publication
(10) Pub. No.: US 2019/0020151 A1
(43) Pub. Date: Jan. 17, 2019

(54) HIGH FREQUENCY ELECTRONIC CONNECTOR

(71) Applicant: C.C.P. CONTACT PROBES CO., LTD., NEW TAIPEI CITY (TW)

(72) Inventors: HAO-WEN CHIEN, NEW TAIPEI CITY (TW); LI-CHUN LAN, NEW TAIPEI CITY (TW); MIN-AN CHING, NEW TAIPEI CITY (TW); PING-HUAN TSOU, NEW TAIPEI CITY (TW); WEN-YING CHENG, NEW TAIPEI CITY (TW); BOR-CHEN TSAI, NEW TAIPEI CITY (TW); TSUNG-MING TSAI, NEW TAIPEI CITY (TW); CHIH-FENG CHEN, NEW TAIPEI CITY (TW)

(21) Appl. No.: 15/650,978

(22) Filed: Jul. 17, 2017

(51) Int. Cl. H01R 13/646; H01R 24/56; H01R 13/6582; H01R 24/48

(52) U.S. Cl. CPC H01R 13/646; H01R 24/48; H01R 13/6582; H01R 24/56

(57) ABSTRACT

A high frequency electronic connector is formed by a first connector and a second connector. The first connector has a first body and at least one first terminal, and the first terminal is built in the first body. The second connector has a second body and at least one second terminal, and the second terminal is built in the second body and provided for inserting and connecting the first body. The first terminal has a front end surface in form of a slope or a curved surface, and the second terminal has a front end surface in form of at least one slope or at least one curved surface, so as to increase the contact area between the first and second terminals, and improve the stability of a high frequency signal transmission.

### FIELD OF INVENTION

The present invention relates to the field of electronic devices, in particular to a high frequency electronic connector that increases the contact area between male and female terminals to improve the integrity and continuity of the transmission of high frequency electronic signals, so as to ensure the stability of the signal quality.

### BACKGROUND OF INVENTION

### 1. Description of the Related Art

To cope with the thin design of mobile devices such as smart phones, tablet PCs, and notebook computers, various related electronic components are developed with thin and light features and high performance. In recent years, electronic products have increasingly higher demand on the application of high speed signals, and the number of connection terminals required by mobile devices and other video and recreational electronic products become increasingly larger. Due to the limitation of the miniaturization of the electronic products, the electromagnetic interference (EMI) effect become a serious issue, and high frequency circuit design and electromagnetic wave protection become very important. Since an electronic signal is transmitted through the current flowing between two terminals, and the flow of current in the terminals produce a magnetic field at the outer side of the terminals (according to the Oersted's magnetic effect of electric current), so that when the total volume of a connector is reduced, and the distance between the terminals becomes very small, electromagnetic interference (EMI) will be produced, and the accuracy and transmission efficiency of signals will be affected.

To overcome the aforementioned problem, the structure of some conventional connectors is changed to improve the quality of high frequency signal transmission, but this solution creates another problem, since the whole structure of the connector becomes more complicated, and the complicated structure is disadvantageous for the production process, particularly when the connection terminals are very small. The components are damaged very often during the assembling process, and the production is increased. In view of the drawbacks of the prior art, it is an important subject for the present invention to improve the stability of high frequency signal transmission and reduce the production failure rate without complicating the design of the connector.

### 2. Summary of the Invention

Therefore, it is a primary objective of the present invention to overcome the drawbacks of the prior art by providing a high frequency electronic connector, wherein the contact area of male and female terminals in the connector is increased to achieve a good high frequency property and reduce the failure rate of engagement.

To achieve the aforementioned and other objectives, the present invention provides a high frequency electronic connector, comprising a first connector and a second connector, and the first connector includes a first body and at least one first terminal, and the first body has the first terminal built therein, and the second connector includes a second body and at least one second terminal, and the second body has the second terminal built therein and provided for plugging the first body, characterized in that the first terminal has a front end surface which is substantially a slope or a curved surface, and the second terminal has a front end surface which is at least one slope or at least one curved surface for increasing the contact area between the first terminal and the second terminal, and improving the stability of a high frequency signal transmission.

Wherein, the high frequency electronic connector is inserted and coupled into a motherboard having a plurality of contacts, and the motherboard is electrically coupled to at least one external electronic device. The electronic device is inserted and coupled to the motherboard through the contacts and electrically coupled to the high frequency electronic connector, or the electronic device is inserted and coupled to the contacts through at least one external cable, and the contacts are electrically coupled to the high frequency electronic connector. At least one of the first and second terminals is elastic, so that when the first connector is inserted and coupled to the second connector, at least one of the first and second terminals elastically absorbs the stress produced at the moment of engagement to improve the overall reliability, and the second body is fixedly or elastically contacted with the first body to achieve an insertion and engagement effect. The front end surfaces of the first terminal and the second terminal area are oblique contact surfaces having an angle of 18-45 degrees with respect to a horizontal plane, and the first terminal and the second terminal are disposed opposite to each other. Alternately, the front end surface of the first terminal is substantially in a convex arc shape, and the front end surface of the second terminal is substantially in a concave arc shape and corresponsive to the front end surface of the first terminal. In an embodiment, the front end surface of the first terminal is substantially in a convex arc shape, and the front end of the second terminal has a plurality of slopes in different shape and disposed continuously around the front end of the second terminal, and two oblique slopes are arranged opposite to each other to form a plurality of cones and a plurality of grooves. Alternately, the front end surface of the first terminal is in a convex curved shape, and the front end of the second terminal has a plurality of convex curved surface disposed continuously around the front end surface of the second terminal.

In addition, the first body and the second body are made of a polymer or an electrically conductive material for enhancing the capability of resisting electromagnetic interference. The second body has at least one hole filled with polymer or air.

In summation, the present invention simply increases the contact area between the front end surface of the first terminal and the front end surface of the second terminal while using the elasticity of the first terminal to reduce the stress produced at the moment of engaging the first connector and the first connector, so that the high frequency electronic connector has a good high frequency produce and reduce the failure rate of engagement, and the high frequency connector of the invention also allows the connector to be plugged and unplugged for many times and improve the overall reliability and quality of the high frequency signal transmission.

### BRIEF DESCRIPTION OF THE DRAWINGS

FIG. 1 is an exploded view of a first preferred embodiment of the present invention;

FIG. 2 is an experiment waveform chart of the first preferred embodiment of the present invention;

FIG. 3 is a schematic view of a terminal of a second preferred embodiment of the present invention;

FIG. 4 is an exploded view of a third preferred embodiment of the present invention;

FIG. 5 is a first experiment waveform chart of the third preferred embodiment of the present invention;

FIG. 6 is a second experiment waveform chart of the third preferred embodiment of the present invention;

FIG. 7 is a schematic view of the third preferred embodiment of the present invention;

FIG. 8 is a schematic view of a terminal of a fourth preferred embodiment of the present invention; and

FIG. 9 is a partial sectional view of the fourth preferred embodiment of the present invention.

### DESCRIPTION OF THE PREFERRED EMBODIMENTS

The above and other objects, features and advantages of this disclosure will become apparent from the following detailed description taken with the accompanying drawings.

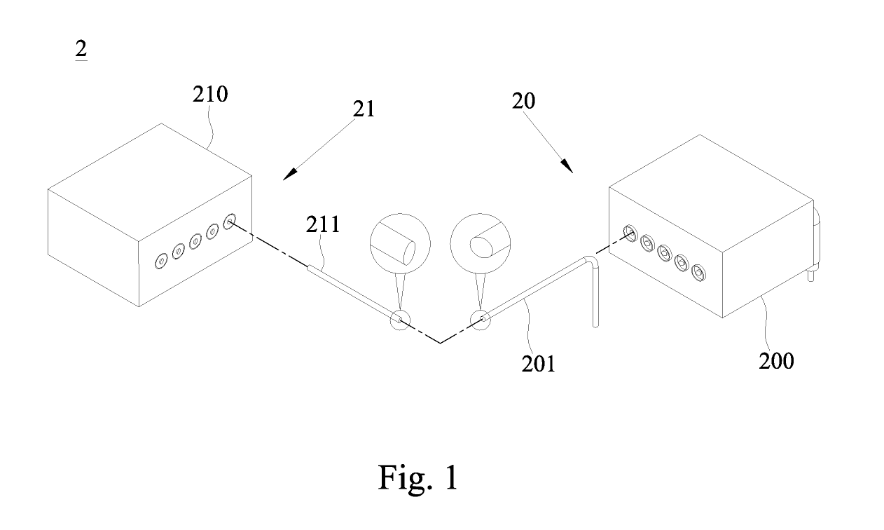

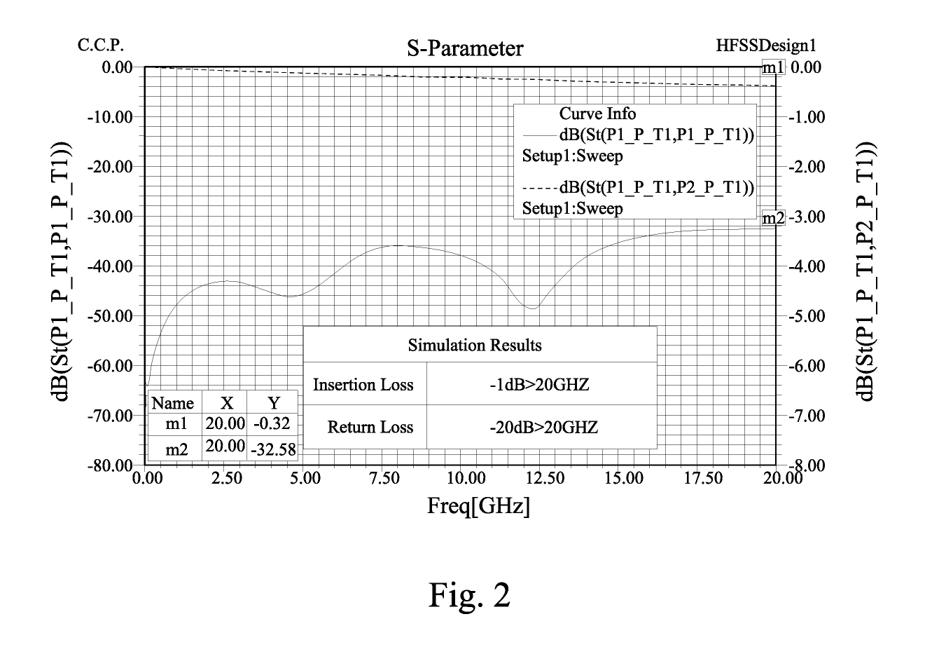

With reference to FIGS. 1 and 2 for an exploded view and an experiment waveform chart of a high frequency electronic connector 2 in accordance with the first preferred embodiment of the present invention respectively, the high frequency electronic connector 2 comprises a first connector 20 and a second connector 21, and the first connector 20 includes a first body 200 and at least one first terminal 201, and the second connector 21 includes a second body 210 and at least one second terminal 211. The first terminal 201 is built in the first body 200, and the second body 210 is provided for inserting and connecting the first body 200 and the second terminal 211 is built in the second body 210. Both of the first terminal 201 and the second terminal 211 have a signal terminal for transmitting signals and a grounding terminal. The front end surface of the first terminal 201 is substantially a slope, and the front end surface of the second terminal 211 is a slope corresponsive to the front end surface of the first terminal 201, and both slopes are oblique contact surface having an angle of 18-45 degrees with respect to a horizontal plane to increase the contact area between the first terminal 201 and the second terminal 211, improve the stability of high frequency signal transmission, and achieve a good high frequency property.

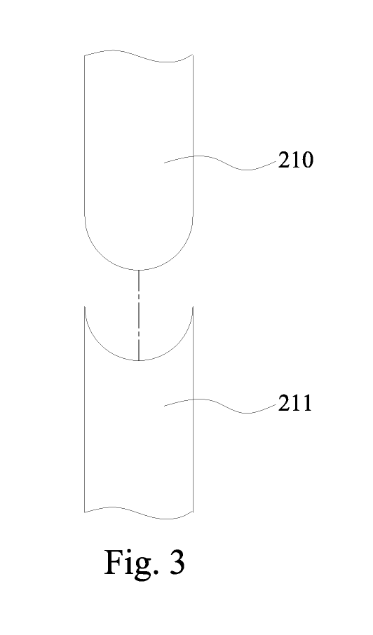

The front end surface of the first terminal 201 is a curved surface, and the front end surface of the second terminal 211 is also a curved surface. In FIG. 3, the front end surface of the first terminal 201 is in a convex arc shape, and the front end surface of the second terminal 211 is in a concave arc shape corresponsive to the front end surface of the first terminal 201 to increase the contact area between the front end surfaces of the first and second terminals 201, 211. In addition, at least one of the first terminal 201 and the second terminal 211 is elastic, so that when the first connector 20 is inserted and connected to the second connector 21, at least one of the first terminal 201 and the second terminal 211 elastically absorbs the stress produced at the moment of engagement to improve the overall reliability. In addition, the first body 200 and the second body 210 may be elastic, so that when the first connector 20 is inserted and connected to the second connector 21, the second body 210 and the first body 200 are engaged with each other through a fixed contact or an elastic contact, so as to achieve the effects of improving the tightness of the connection, preventing damages of components, and improve the effect of resisting electromagnetic interference.

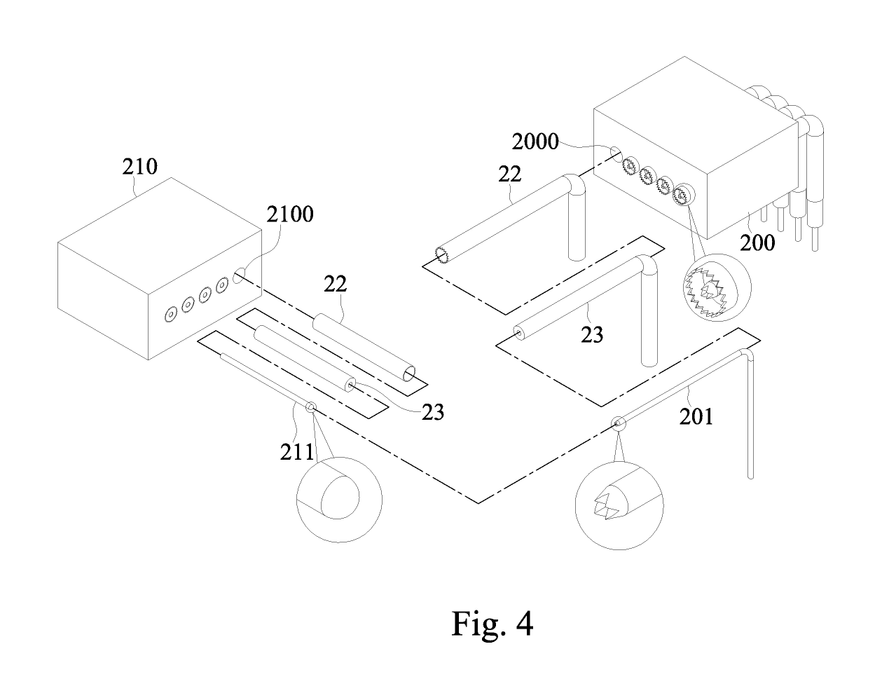

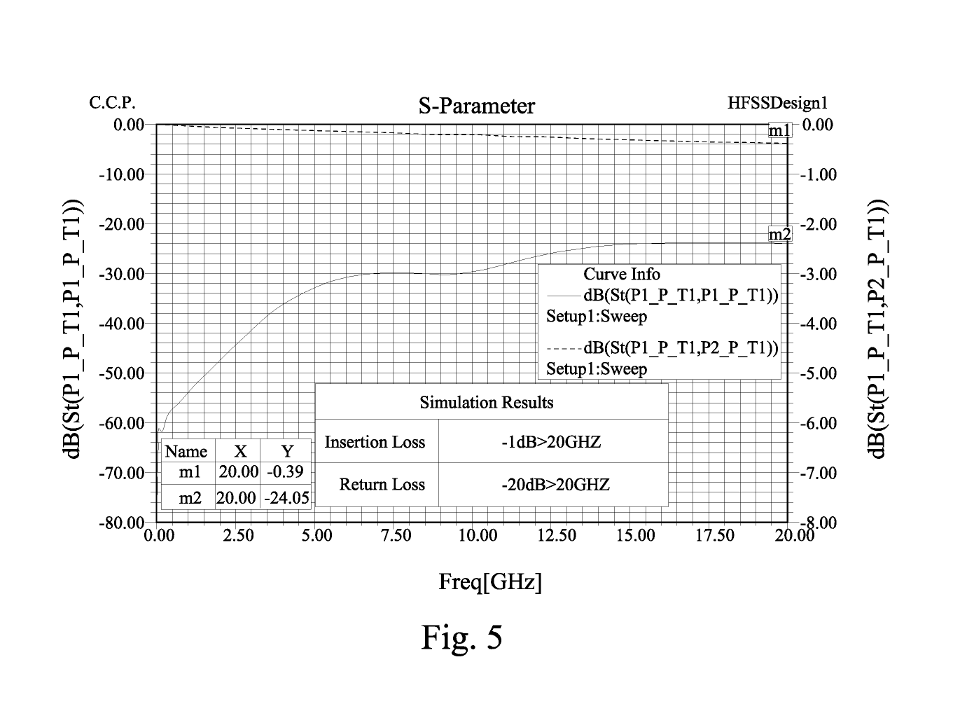

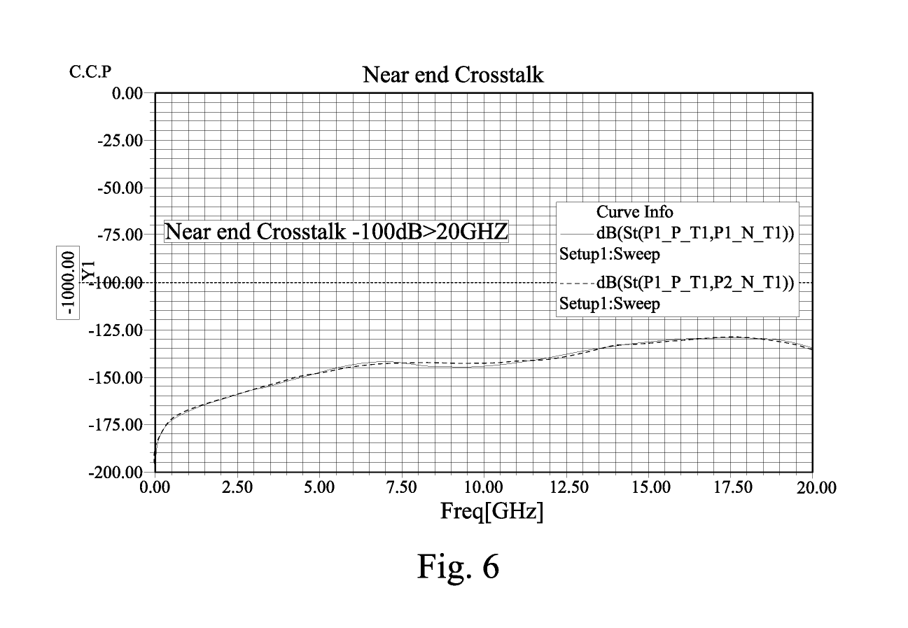

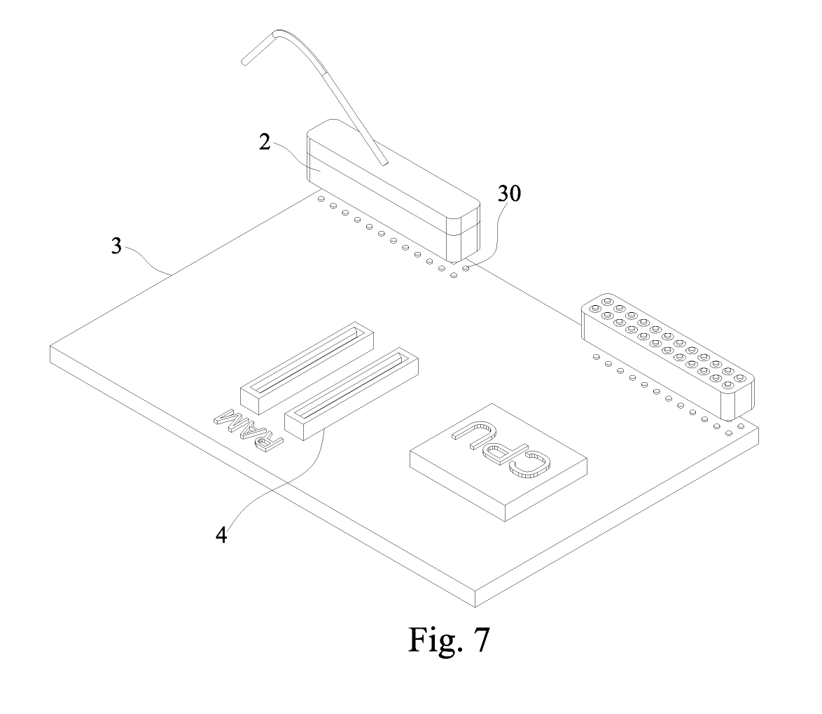

With reference to FIGS. 4-7 for an exploded view, experiment waveform charts, and a schematic view of a high frequency electronic connector 2 in accordance with the third preferred embodiment of the present invention respectively, the high frequency electronic connector 2 comprises a first connector 20 and a second connector 21, and the first connector 20 includes a first body 200 and at least one first terminal 201, and the second connector 21 includes a second body 210 and at least one second terminal 211, wherein the first body 200 and the second body 210 are made of a polymer, an electrically conductive material, or any other electrically conductive device to enhance the capability of resisting electromagnetic interference. The first body 200 is a modular structure and has at least one first hole 2000, and the first hole 2000 contains a shielding film 22 and the first terminal 201, and a polymer 23 or air is filled between the shielding film 22 and the first terminal 201. The second body 210 is inserted and connected to the first body 200, and also has at least one second hole 2100, and the second hole 2100 contains the shielding film 22 and the second terminal 211, and the polymer 23 or air is filled between the shielding film 22 and the second terminal 211. Both of the first terminal 201 and the second terminal 211 has a signal terminal for transmitting signals and a grounding terminal.

The front end surface of the first terminal 201 is a curved surface, and the front end surface of the second terminal 211 is at least one curved surface. For example, if the front end surface of the first terminal 201 is in a convex arc shape, the front end of the second terminal 211 has a plurality of slopes in different shapes disposed continuously around the front end of the second terminal 211, and two oblique slopes in different directions have a plurality of cones and a plurality of grooves, so that when the two terminals are engaged, the convex arc shape of the first terminal 201 may use the sharp cones to scrape a surface oxide layer while increasing the contact area between the first terminal 201 and the second terminal 211, improve the stability of high frequency signal transmission, and achieve a good high frequency property.

In addition, the high frequency electronic connector 3 may be inserted and connected to a motherboard 3 having a plurality of contacts 30 by users or installed directly onto the motherboard 3 in factory, and the contacts 30 are provided for inserting and connecting at least one electronic device 4 including a PCI, a memory socket, south and north bridges, a motherboard power socket, a processor power socket or a SATA socket, so that the high frequency electronic connector 3 is electrically coupled to the external electronic device 4 through the motherboard 3. Of course, the electronic devices 4 may be plugged into the high frequency electronic connectors 3 installed in the same motherboard 3 and electrically coupled to constitute a loop, or the electronic device 4 may be connected to the contact 30 through at least one cable (not shown in the figure) and electrically coupled to the high frequency electronic connector 2.

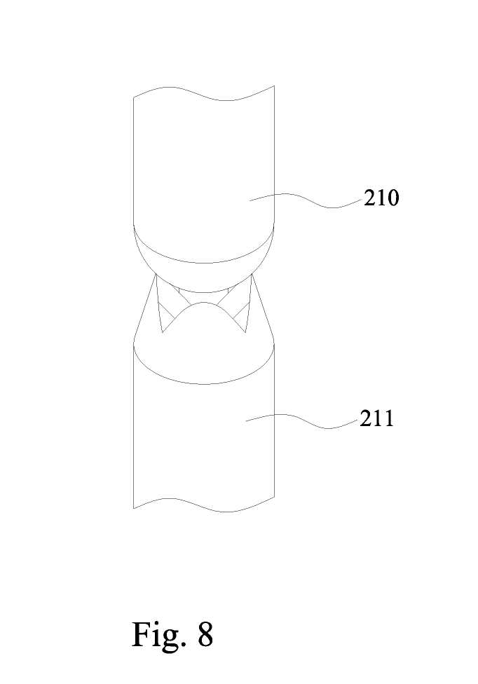

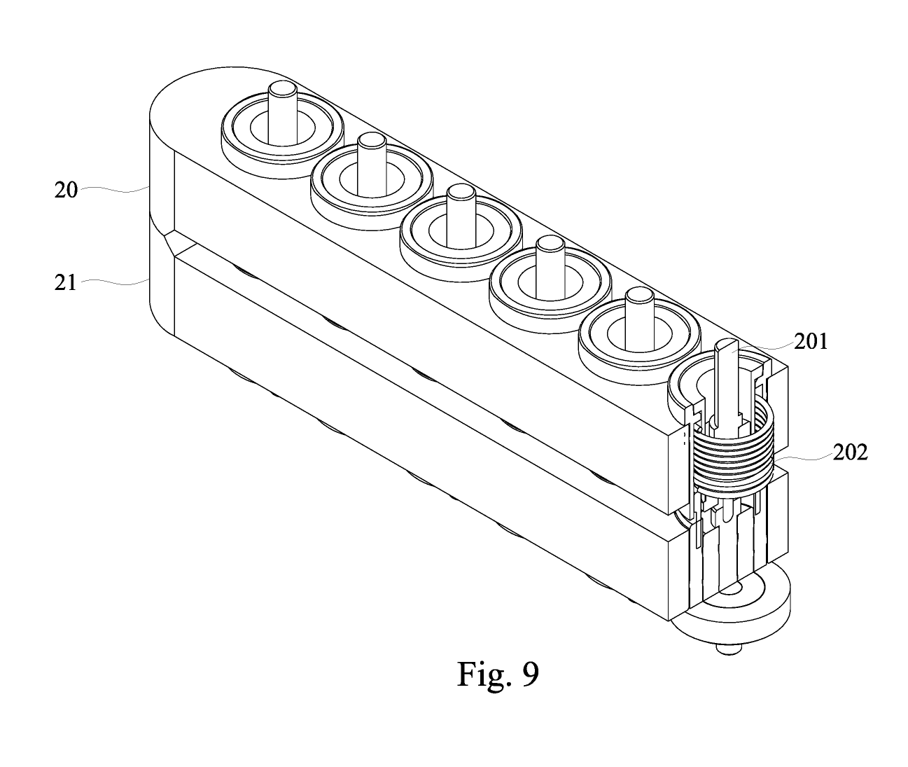

In FIG. 8, the front end surface of the first terminal 201 is a convex curved surface, and the front end of the second terminal 211 has a plurality of convex curved surfaces in different shapes continuously disposed around the front end of the second terminal 211, so that the front end of the second terminal 211 looks like having a plurality of hemispheres or a wavy surface. In FIG. 9, the first connector 20 may have at least one elastic member 202 such as a spring, so that the first terminal 201 is elastic, and when the first connector 20 is inserted and connected to the second connector 21, the first terminal 201 uses its elasticity to absorb the stress produced at the moment of engagement, so as to improve the overall reliability. Of course, the elastic member 202 is not limited to be arranged at the first terminal 201 only, but it may be disposed around the second terminal 211, so that the second terminal 211 can provide the elasticity for engagement or connection.

What is claimed is:

1. A high frequency electronic connector, comprising of a first connector and a second connector, and the first connector including a first body and at least one first terminal, and the first body having the first terminal built therein, and the second connector including a second body and at least one second terminal, and the second body having the second terminal built therein and provided for plugging the first body, characterized in that the first terminal has a front end surface which is substantially a slope or a curved surface, and the second terminal has a front end surface which comprises at least one slope or at least one curved surface for increasing the contact area between the first terminal and the second terminal, and improving stability of a high frequency signal transmission.

2. The high frequency electronic connector of claim 1, wherein the high frequency electronic connector is inserted and coupled into a motherboard having a plurality of contacts, and the motherboard is electrically coupled to at least one external electronic device.

3. The high frequency electronic connector of claim 2, wherein the electronic device is inserted and coupled to the motherboard through the contacts and electrically coupled to the high frequency electronic connector, or the electronic device is inserted and coupled to the contacts through at least one external cable, and the contacts are electrically coupled to the high frequency electronic connector.

4. The high frequency electronic connector of claim 3, wherein at least one of the first and second terminals is elastic, so that when the first connector is inserted and coupled to the second connector, at least one of the first and second terminals elastically absorbs the stress produced at the moment of engagement to improve the overall reliability, and the second body is fixedly or elastically contacted with the first body to achieve an insertion and engagement effect.

5. The high frequency electronic connector of claim 4, wherein the front end surfaces of the first terminal and the second terminal area are oblique contact surfaces having an angle of 18-45 degrees with respect to a horizontal plane, and the first terminal and the second terminal are disposed opposite to each other.

6. The high frequency electronic connector of claim 4, wherein the front end surface of the first terminal is substantially in a convex arc shape, and the front end surface of the second terminal is substantially in a concave arc shape and corresponsive to the front end surface of the first terminal.

7. The high frequency electronic connector of claim 4, wherein the front end surface of the first terminal is substantially in a convex arc shape, and the front end of the second terminal has a plurality of slopes in different shapes and disposed continuously around the front end of the second terminal, and two oblique slopes are arranged opposite to each other to form a plurality of cones and a plurality of grooves.

8. The high frequency electronic connector of claim 4, wherein the front end surface of the first terminal is in a convex curved shape, and the front end of the second terminal has a plurality of convex curved surface disposed continuously around the front end surface of the second terminal.

9. The high frequency electronic connector of any one of claim 1, wherein the first body and the second body are made of a polymer or an electrically conductive material for enhancing the capability of resisting electromagnetic interference.

10. The high frequency electronic connector of claim 9, wherein the second body has at least one hole filled with polymer or air.

11. The high frequency electronic connector of any one of claim 2, wherein the first body and the second body are made of a polymer or an electrically conductive material for enhancing the capability of resisting electromagnetic interference.

12. The high frequency electronic connector of claim 11, wherein the second body has at least one hole filled with polymer or air.

13. The high frequency electronic connector of any one of claim 3, wherein the first body and the second body are made of a polymer or an electrically conductive material for enhancing the capability of resisting electromagnetic interference.

14. The high frequency electronic connector of claim 13, wherein the second body has at least one hole filled with polymer or air.

15. The high frequency electronic connector of any one of claim 4, wherein the first body and the second body are made of a polymer or an electrically conductive material for enhancing the capability of resisting electromagnetic interference.

16. The high frequency electronic connector of claim 15, wherein the second body has at least one hole filled with polymer or air.

17. The high frequency electronic connector of any one of claim 5, wherein the first body and the second body are made of a polymer or an electrically conductive material for enhancing the capability of resisting electromagnetic interference.

18. The high frequency electronic connector of claim 17, wherein the second body has at least one hole filled with polymer or air.

19. The high frequency electronic connector of any one of claim 6, wherein the first body and the second body are made of a polymer or an electrically conductive material for enhancing the capability of resisting electromagnetic interference.

20. The high frequency electronic connector of claim 19, wherein the second body has at least one hole filled with polymer or air.
